(19) United States
(12) Patent Application Publication
(10) Pub. No.: US 2007/0020584 A1
(43) Pub. Date: Jan. 25, 2007

(54) Dental treating process using a treatment agent, dental tray, and a catalytic source

(76) Inventor: George Willam Madray, Burnswick, GA (US)

Correspondence Address: Dr. George W. Madray, 124 Carteret Rd., Brunswick, GA, 31525, US

(21) Appl. No.: 11/489,140

(22) Filed: Jul. 19, 2006

Related U.S. Application Data
(60) Provisional application No. 60/700,722, filed on Jul. 20, 2005.

(51) Int. Cl. A61C 5/00

(52) U.S. Cl. 433/215

(57) ABSTRACT

An improved process for treating teeth using a teeth cover, a treatment agent, and a catalytic source. The cover can be fitted by the wearer, instead of having to go to a dentist, by placing it against the teeth in one or both arches. A treatment agent is placed inside the cover, an external catalytic source catalyzes the agent, and the agent is placed against the teeth for a beneficial treatment. The treatment time is shortened by the process.

### CROSS-REFERENCE TO RELATED APPLICATIONS

This application claims benefit of U.S. provisional application Appl. No. 60/700,722 filed Jul. 20th, 2005 entitled “DENTAL TREATING PROCESS USING A TREATMENT AGENT, DENTAL TRAY, AND A CATALYTIC SOURCE”; of which previous application is incorporated by reference to the fullest extent permitted by law.

### BACKGROUND OF THE INVENTION

The prior art shows teeth treatment using teeth covers containing various agents to facilitate teeth whitening, teeth cleaning, oral tissue treatment, and oral disinfection. More recently, catalytic agents have been used to accelerate that treatment. Teeth covers have been formed from wax, synthetic polymers that are flexible and shape retaining, strips of different plastics, preformed stock trays, custom trays made from thermoplastic preformed trays alone or in combination with more rigid stock trays, and dentist fabricated trays. They include bleaching, whitening, disinfecting and oral health and cosmetic agents. Catalytic sources such as ultrasonic transducers, heat, and light, have been used to accelerate the desired treatment.

Different covers are used as receptacles to carry a medicine or dental hygiene material, such as whitening agents or fluoride application, which are then applied to the teeth. The cover confines the material next to the teeth during treatment. Whitening is becoming more popular with the general public because the public places more emphasis on wants rather than needs. Teeth whitening systems became available in 1989, in the form of a custom made tray made by a dentist. Later that same year, this inventor introduced the world to an over-the-counter (OTC) method that allowed for a custom fitted mouth tray at home by the user, allowing for whitening teeth at home. This started what would become a world-wide whitening craze. His method would later become U.S. Pat. No. 5,076,791. Because “at home” whitening methods are more convenient, and affordable, numerous products have since been developed which provide an individual with the means to treat and whiten his or her teeth in the privacy and convenience of [their] <his/her> home.

Prior to tray systems, an individual desiring whiter teeth was subjected to various heat or light activated systems provided by dentists. They generally applied a hydrogen peroxide solution on the teeth. The sensitive soft tissues were protected with a rubber dam, and heat was applied to the solution to cause oxidation. Such oxidation generally removed discoloration from the tooth surfaces. These in-office procedures were generally expensive, often costing hundreds of dollars.

Currently, there are several home methods for treating/whitening an individual's teeth; one whitening process utilizes the paint-on method, which can be traced back to 1907. It involves painting hydrogen peroxide on the teeth. This method has been brought back with great popularity by Colgate. It is not very effective, since the effectiveness of bleaching is determined by the contact time of the bleach on the teeth. In this case one wipes the gel on his/her teeth with a brush and then soon wipes it off with his/her lips.

The following whitening processes use teeth covers. Teeth covers as seen herein are exemplified by things that are placed in close proximity or against ones teeth. One method involves the use of preformed flexible stock dental trays. This method produces little whitening with a lot of gel. A lot of gel is required to fill the tray, which does not snugly fit against the teeth, thus allowing saliva, with its peroxidase, that not only dilutes the whitening gel, but breaks down the peroxide ingredient. It is cumbersome to wear. A second method uses a strip. Popularized by Procter & Gamble, the strips generally whiten only the front teeth. It is pretty good if one smiles like a fish—showing only the front teeth. It is also preferable that ones teeth are straight, because the strip has difficulty reaching teeth that are not in alignment. They are expensive, but very inconspicuous—due to their thinness. But, hopefully one does not sneeze during wear, or it could be gone with the wind. A more recent method uses dry polymer patches. They are pre molded and adapted directly against ones teeth at room temperature. They can be a bit bulky and conspicuous. They are not reusable, but can whiten more teeth than the strip method. They are outlined in U.S. Pat. No. 6,682,721.

The latest process uses a preformed wax pattern that is adapted to ones teeth. It remains to be seen what acceptance a wax will have in the market place and the associated problems with this technique. It is illustrated in U.S. Pat. No. 6,896,518. The final method, disclosed in U.S. Pat. No. 5,076,791 issued to this inventor; and U.S. Pat. Nos. 5,616,027; 5,769,633; 6,848,905 issued to Jacobs et al., involve a “boil & bite”, customized tray which is fitted directly to ones teeth. As its name sake suggests, the trays are warmed and formed to custom fit to ones teeth, whereby each tray is in juxtaposition with the teeth, snugly encompassing them. The gel stays away from saliva. They can be made from very thin, stock preformed trays, for a comfortable, snug fit. If they are substantially “U” shaped, in cross-section, they can provide for a balanced occlusion—an interdigitation with the teeth, or tray in the opposite arch. It is the method closest to a dentist' laboratory formed tray, which has been equilibrated, to allow for simultaneous contact of the posterior and anterior teeth with the tray, upon occluding (closure). The treatment covers can have reservoirs for added surface area to enable treatment. The reservoirs can be formed by having a material inserted into a preformed tray and then directly adapting the tray to ones teeth as known in the art. This can also be done with “block-out” material of wax or plastic in the mouth or laboratory.

Teeth treating agents are agents that can be used to make the teeth and/or gums healthier or cosmetically more pleasing. There are for example, antibacterial agents, anticariogenic agents, desensitizing agents, plaque and tartar removing agents, remineralizing agents and breath freshening agents to name some. Chlorine dioxide, clorhexidine, triclosan, chlor-haidine, potassium nitrate, sodium fluoride, sodium monofluorophosphate, pyrophosphate, polyphosphate, and enzymes are included as representative sample agents. Finally, and what most want, are whitening agents.

Examples of whitening agents include peroxides, metal chlorites, perborates, percarbonates, peroxyacids, persulfates, compounds that form the preceding compounds in situ, and combinations thereof. They can be any oxidizing or reducing substance. Suitable peroxide compounds include hydrogen peroxide, urea peroxide, calcium peroxide, carbamide hydrogen peroxide, and mixtures thereof. Suitable metal chlorites include calcium chlorite, barium chlorite, magnesium chlorite, lithium chlorite, sodium chlorite, potassium chlorite, and mixtures thereof. Additional whitening agents also include hypochlorite, chlorine dioxide, sodium percarbonate, oxones, and mixtures thereof. The agent can be an aqueous or solid material.

Tooth whitening agents are present in an amount of from about 0.01% to about 40%, by weight hydrogen peroxide. It is preferably from 3.6% to 6%, by weight of the gel, for at home use. Carbamide peroxide is generally present at nearly three times the concentration, or 10% to 15% to achieve the same chemical equivalency. This is the amount that has been approved by the FDA for treatment as a drug for oral wound cleansers.

The agents are generally contained in an aqueous gel. The gel is a high viscosity matrix formed from gelling agents known in the art. These gelling agents are safe for oral use, do not readily dissolve in saliva, and do not react with or inactivate the oral care agents incorporated into them. Suitable thickening agents used with the treating agents include carboxypolymethylene (Carbopol RTM), carboxymethyl cellulose, carboxypropyl cellulose, poloxamer, carrageenan, Veegum (RTM), PVP, carboxyvinyl polymers, and natural gums such as gum karaya, xanthan gum, guar gum, gum arabic, gum tragacanth, and mixtures thereof. The preferable gelling agent should be compatible with the treating agents, stable, and not harmful to the oral cavity. Generally, the thickening agent is a swellable polymer. It also imparts sufficient adhesive attachment of the treatment tray to the targeted area of the mouth.

In the prior art different agents have been incorporated into whitening gels which are used to accelerate the formation of free radicals and perhydrol anions that are responsible for whitening. Ions that are highly sensitive to heat may be used to accelerate the breakdown of peroxides during the bleaching process. Most popular are photosensitizing agents.

Photosensitizing agents useful in accomplishing the desired tooth whitening effect include any compounds capable of absorbing light energy at biologically acceptable wavelengths prescribed by the limits of safety for use in the oral cavity. In general, such wavelengths are from about 350 nanometers (nm) to about 700 nm, encompassing a portion of the UVA spectrum (300 to 400 nm) and most of the visible light spectrum (400 to 700 nm).

Peroxide whitening gels that have been formulated with other active oxygen compounds are photosensitive. Those compounds are preferably selected from the group consisting of ammonium persulfate, sodium persulfate, and potassium persulfate and have a final concentration in the mixture between 1% and 80%. These compounds are used because they are particularly sensitive to light, and release free oxygen radicals in the process.

Whitening gels that contain peroxide are able to be photosensitive if they have certain agents incorporated within them. It has been found that radiant-energy absorbable, substantially conjugated hydrocarbons are the preferred whitening agent activators since they appear to be significantly stable in the presence of peroxides. In other words, they themselves resist oxidation or bleaching in the presence of the whitening agent. These agent activators are defined as substantially conjugated hydrocarbons such as multiple benzene structures, conjugated hydrocarbon chains, and combinations thereof that absorb portions of the electromagnetic spectrum and have simple hydrogen, hydroxyl, or carboxylic groups attached to the structures and act as energy-absorbing substances.

The ability of certain metal chelates to act as photosensitizers has been noted in the literature by various workers. Obviously, only those compounds that are stable in a highly oxidative environment are suitable for inclusion directly in the oxidizing composition. One example of such a compound is 1-hydroxyethylidene-1,1-diphosphonic acid (available commercially under the trade name Dequest 2010 and sold as a 60% active solution by Monsanto Corporation, St. Louis, Mo.).

The ability of certain metal chelates to act as photosensitizers has been noted in the literature by various workers. For example, Van der Zee, et al (“Hydroxyl Radical Generation by a Light-Dependent Fenton Reaction” in Free Radical Biology & Miedicine, Vol. 14, pp 105-113, 1993) described the light-mediated conversion of Fe (III) to Fe (II) in the presence of a chelating agent and hydrogen peroxide. This inventor himself was formulating whitening compounds for MoycoUnion Broach, Montgomeryville, Pa., the manufacturers of the “Illumintor”—which catalyzes whitening gels with heat and light, that contained Dequest as early as 1990.

Examples of compounds which may convert light energy to either heat or chemical energy, include semiconductor particles (particularly nanometer-scale titanium dioxide and zinc oxide), benzophenone derivatives, benzotriazole derivatives, diketones (such as camphorquinone and benzil), metal-ligand complexes (such as ferric potassium oxalate, manganese gluconate, and various metal bisphosphonate chelates), phthalocyanin-metal complexes, and others. A specific example of a suitable photosensitizing composition is an aqueous dispersion of zinc oxide with particle sizes between 5 and 20 nanometers. An oxidizing agent, is contemplated to have utility in the practice of the present invention.

Other photo sensitizers belong to the general class of water-soluble metal-ligand complexes which absorb light in the range of from about 350 nm to about 700 nm. Suitable metals ions include iron, manganese, copper, and other transition metal ions. Examples of metal-coordination complexes are formed from the association of iron, manganese and copper with chelators such as ethylenediamine tetraacetic acid (EDTA), diethylenetriamine pentaacetic acid (DETPA), nitrilotriacetic acid (NTA), 1-hydroxyethylidene-1,1-diphosphonic acid, ethylenediamine tetra(methylenephosphonic acid), diethylenetriamine penta(methylenephosphonic acid), and polyols such as sorbitol, xylitol, mannitol, maltitol, lactitol and other non-carboxylated polyhydroxy compounds.

Colored pigments can act as photo sensitizers. Depending on the color of the light used, the pigment which is on the opposite side of the “color wheel” is chosen. For example a blue-green light would use a yellow-orange pigment.

Catalytic sources that have been used to accelerate or promote chemical and metabolic processes have included U.V. light, visible light, infrared, ultrasound, metallic elements and ions—such as used in altering of the pH of the gel. Any form of electromagnetic radiation can be used—including heat.

### SUMMARY OF THE INVENTION

Objects and advantages of the invention will become apparent from a consideration of the descriptions herewith. It is contemplated that the invention could be used with laboratory formed trays that use a vacuum formed process, after taking an impression, to make a tray or trays. That process is well known in the art. In a dental office high concentrations of hydrogen peroxide, such as 35% are used. In that case a liquid dam would be used, if the invention is used with concentrated peroxide. The tray would be beneficial because the active oxygen gas would be retained against the teeth, driving the bleaching ions down into the teeth.

Unfortunately, despite improvements in the OTC “at-home methods”, there remain disadvantages and limitations. A significant disadvantage of the known in-home approaches is the longer application or contact time needed by these methods. Because of the required longer contact time, treating agents must be frequently replaced during application. Replenishment is needed because of saliva dilution and swallowing of the agent causing the agent in the teeth cover to diminish. In the case of a whitening treatment with peroxide, the saliva additionally breaks down the peroxide. Therefore, because of the inconvenience of replacing teeth treating agents frequently and the slower chemical reaction times, it is apparent a need exist in the art for an improved process of treating teeth. Additionally, it would be advancement in the art to provide faster acting dental whitening treatments which takes place outside a dental office and without the need for a dentist.

Some useful results have been experienced using the above OTC treatment methods—particularly the custom formed tray that is formed at home. While any of the teeth covers can be used, it is particularly the generally transparent, flexible trays that are used with the inventive process herein. Non customized trays can be used. Dental trays which are generally U-shaped, but even L-shaped and configured for teeth treatments such as whitening and the like, can be used. They need to be flexible enough to conform to the patient's upper and/or lower teeth and be in close proximity to the teeth to cause the treating agent to contact the teeth and perform its intended function. Trays (upper and lower), that are joined in the posterior on a hinged axis, as disclosed in U.S. patent application Ser. No. 20040152050 to Ibsen, are preferable over ordinary individual or dual (connected together) stock trays. Dual connected stock trays require the user to keep their mouth closed continually during treatment. More gel is required and saliva gets into the tray causing considerable foaming not to mention inactivating the peroxide—if that is the treating agent.

Dual trays that are to treat the upper and lower teeth simultaneously and have little to no grip against the teeth require the user to continually bite. This clenching can produce muscle strain after a very short time. The present invention allows the jaws to be at what is known in dentistry as the “rest position”. This is a position that has the teeth in each arch, slightly apart—not touching the teeth in the opposing arch. This is a position that is comfortable and healthy.

Whitening is the most desirable teeth treating method, and the one that is most commonly used with a catalyst. It should be kept in mind that earlier treatments mentioned above can also be used with the invention. For example, several researchers have shown that combinations of certain photo-reactive agents and low light levels exhibit very potent cytotoxicity. They have shown that more than 99% of gram-positive Staphylococcus aureus and Streptococcus faecalis bacterial cultures can be killed with the application of light from a tungsten bulb. Ostler et al.—Pat. App. # 20050074723 discloses that ultrasonic energy in the proximity of 35 KHz can be used to whiten teeth, fight plaque and even bad breath. Ultrasound is shown to accelerate and intensify chemical reactions between peroxide and other whitening constituents, consequently accelerating and enhancing the release of oxygen ions from the peroxide, which in turn accelerates and enhances the whitening of the dentition. The ultrasound transducer is embedded in a housing that can be held by the lips and/or teeth. For example, the transducer is in a lip closure hub—in front of ones teeth, in a horseshoe shaped bite fork—between and occluded on by the teeth, or a combination of both.

Some dentists have found that the effectiveness of some chemical whitening compounds is enhanced by the application of a suitable light source on a tooth surface that has a whitening compound upon it. Color in organic compounds is usually attributed to chromophores, which are unsaturated groups that can undergo pi electron transitions. Conjugated double bond systems are attacked that are responsible for color—see an article by this inventor titled “Chemical, Optical, and Physiologic Mechanisms of Bleaching Products: A Review” Vol. 3, No. 2 1991, published in the Journal of Practical Periodontics and Esthetic Dentistry, March, 1991. Light can activate stain chromophores (undergo electronic transition), and reduce activation energy barrier making them more susceptible to attack by bleaching. In other words, activation of color bodies via light may enhance peroxide bleaching.

A similar invention, to this disclosure, is disclosed by Creamer in U.S. patent application Ser. No. 20050048444. His invention has a bottom rigid tray which is fixable attached to a pliable silicone stock dental tray, which receives the teeth to be whitened. The rigid tray is equipped with a fiber optic bundle or one or more light emitting diodes (LEDs) that produce a light having a selected wavelength. The light source emits from the rigid tray, which is attached to a light source housing that catalyzes the peroxide. The user has to bite on the rigid portion to hold the rigid tray with the LED or fiber optic bundle. This requires clenching, of primarily the anterior teeth, producing fatigue after only a short time. Furthermore, the stock trays allow dilution and inactivation of the whitening gel.

In this inventor's invention, the catalytic source, bite fork and/or lips held hub, is not attached to the tray. Once a catalytic source exposes the whitening gel and activates the peroxide, it can be removed. It can activate the peroxide soon after the tray is inserted, after a short to intermediate time, or later, after the gel has had time to penetrate deeper into the teeth. Also, the light source does not have to be held by the user's teeth. It can be held by only the lips, or it can be as external as the ultraviolet light of a tanning bed/booth. In that case, the lips and cheeks of the user are held back by a lip and/or cheek retractor. Also, a teeth treating agent can be exposed by say a microwave oven and then placed in the mouth.

Unfortunately, such light-activated bleaching processes are often only offered through professional dental practices or clinics, and impart significant costs for a patient desiring whitening. This is circumvented by the present invention.

### DETAILED DESCRIPTION OF THE INVENTION

The treating agent is preferably a dental whitening composition. It is employed in the process by brushing a gelled agent onto the teeth or adding it into a dental cover/tray before the user inserts the tray into their mouth. Then, the tray or trays are used in conjunction with a separate catalytic source. Ultrasound, or heat can be used, but it is preferable to illuminate the surfaces of his/her teeth with a light source. The light source illuminates the coated teeth for perhaps a short time, only 5 minutes, or more. The user can then remove the light source and continue to wear the tray for a longer treatment time after the peroxide has kicked off a free radical chain reaction. One can also wear the tray for a longer time, to allow time for the whitening agent to penetrate further into the teeth, and then activate the whitening agent with the light source, to whiten deeper within the teeth.

In one preferred embodiment, the catalytic source, as a horseshoe shaped, bite fork, is held by only the posterior teeth which allow the masseter muscles to easily hold it. In that case, a structure which runs parallel to the occlusal plane must be provided that is attached to the catalytic source. The masseter muscles are the large closing muscles which don't easily tire that run perpendicularly to ones occlusal bite plane. The masseter muscles will not physiologically engage (contract) when ones molars are not engaged. When only ones anterior teeth are in occlusion, the ptyerogoid muscles begin to tire in only minutes. In the Creamer invention, principally the anterior teeth engage his tray, and not the molar teeth. This is due to a “one size fits all” stock tray which is impossible to design to fit the molars of all users. In his invention the user thus easily tires from trying to whiten his/her teeth, particularly when the tray/light source can not be disengaged from one another. His method requires the light source housing/rigid tray to be held throughout the treatment time.

In another preferred embodiment, a separable catalytic source, with electrical circuit housing, may be held by only the lips. It will have a lip closure hub, thereby facilitating the comfortable closure or wrapping of a user's lips there around, further preventing spillage of any oral fluids. The lip hub, which has no bite plane extending between the user's teeth, but can, fit smoothly against the labial surfaces while ones teeth are in occlusion. It encompasses a labial flange that would be great enough in a superior—inferior dimension to cover the upper and lower teeth and gums, yet not be so great as to impinge onto or into ones vestibule or to be uncomfortable to any associate alveolar processes. It would naturally follow the semi-circular curvature of the dental arch to at least or about the location of the canine/First bicuspid area. The hub is located facially (outside) of the user's teeth, and inside of the user's lips. An external section or housing containing a power source, for example, an illumination means, is connected to a power source and is coupled to the hub in any known conventional manner. The housing section is thus suspended externally of the user's mouth when the hub section is placed within the user's lips and therefore, in the user's mouth, whereby the lips alone support the hub and the connected housing. The housing may also include a cover which facilitates removal and replacement of batteries located in the housing, and provides a circuit containing at least one light source, an on/off switch and/or audible timer. This would allow the user to have his/her jaw slightly opened (with teeth apart), at the natural rest position that jaws prefer, and enable the light in this example, to shine into the mouth, past the labial surfaces of the anterior upper and lower teeth.

The catalytic source in one embodiment can use traditional small bulbs—which can even be similar to the wavelength of an infrared heat lamp. The temperature produced by such a bulb raises the temperature of the treatment composition. The increased temperature helps decompose a peroxide whitening gel by a factor of about 2.4 for every 10 degrees Celsius, rise in temperature. An electrical resistant element can also be incorporated into the catalytic source. An electrical circuit would allow the dental tray to warm to approximately 100 degrees Fahrenheit.

In another embodiment, light emitting diodes (LEDs), of different wavelengths (colors) can be used—such as white, amber, green, or blue, preferably from 350 nm to 490 nm (lavender to blue). More particularly preferable is that portion of the electromagnetic spectrum that does not contain visible light—the unseen portions—ultra violet light, and infrared. This is because hydrogen peroxide is known to form bleaching ions when exposed to these unseen portions of the spectrum.

Of particular interest are individual diodes and diode arrays that are incorporated into the invention. They can be located in front of the teeth, and inside or between the lips. A light source according to the invention can be battery powered, which is in a housing, outside of the mouth, allowing for hands free operation of the teeth treating process, being totally supported by the lips. LEDs are supplied for example by Nichia Corporation, of Japan. The LEDs have different specifications such as chromaticity, luminous intensity, forward voltage and directional characteristics.

The whitening agent is one that is accepted by the country that the process is to be sold in, which is safe, stable and effective. A preferred home concentration is from 3.6% to 8% hydrogen peroxide, or its equivalent—10% to 22% carbamide hydrogen peroxide—and more preferably 6% hydrogen peroxide, including some photosensitive persulfate—which is sensitive to light. The gel is thickened with about 1.8% Carbopol RTM. To the gel a photosensitive activator such as a yellow pigment and/or Dequest 2010, can be added that would react with a blue light and/or visible wave length light.

The preformed, stock mouth tray is preferably, substantially U-shaped, and is custom formed within the mouth. The user softens the tray by warming it by a heat source—preferably in water to a temperature in excess of 98.6 degrees Fahrenheit (human body temperature). The tray is then manually adapted to the upper teeth and gums, and one occludes while applying suction and pressure from the tongue and lips, without biting too firmly and through the tray. After a few seconds of setting the tray is removed, placed in cool water and any processing tab attached to the tray is removed. A second tray can be fabricated over the lower teeth by the same process as used for the upper, while the upper tray is on the upper teeth.

This process/method will give a balanced occlusion, because the trays interdigitate with each other. By forming the upper tray first, one can bleach only the upper teeth and the upper tray will interdigitate with the lower teeth for a simultaneous contact of the tray with the lower teeth upon closure of the mouth—as in swallowing. This will give a very comfortable fit that does not tweak the temperomadibular joint (TMJ). This provides for what is known as freeway space, where in opposite arches, the teeth and tray or the tray and tray do not contact each other while the jaw is at its rest position. The treatment tray snugly encompasses the teeth—is in juxtaposition—and stays in place. Very little, expensive photosensitized gel, for example, is necessary during treatment because of the close contact of the tray with the teeth—there is very little void space. Saliva with its peroxidase is not allowed to enter to dilute or cause dismutation of the peroxide gel to produce oxygen and water rather than bleaching ions.

The preformed tray can be made from ethylene vinyl-acetate (EVA) such as Elvax 250 RTM by DuPont. But more preferably is made from ultra low density polyethylene (ULDPE) such as Attane 4203 RTM, by Dow Chemical (polyethylene copolymers made from ethylene and octane) or Exact 4041 RTM, made by Exxon-Mobil Chemical, or from a combination of EVA and ULDPE. The ULDPE material is preferred due to its unique ability to soften and yet maintain its physical integrity while in a softened state, as compared to EVA. Therefore, ULDPE increases the working time, for customizing the dental trays. The ideal thickness is about 0.3 mm to about 1.8 mm, and more preferably from 0.7 mm to about 1.2 mm.

Alternately, an impression can be taken using a suitable, stable impression material such as vinyl polysiloxane. A sheet material from about 0.5 mm to 1 mm (EVA or ULDPE) is vacuum or pressure formed over the cast model made from the impression. The tray is either festooned around the gingival margin, and free gingival papillae, or cut from 1-8 millimeters above the free gingival papillae and free gingival margin.

The present invention may be embodied in other specific forms without departing from its spirit or essential characteristics. The principles, preferred embodiments and modes of operation of the presently disclosed dental treating process have been described in the foregoing specification. The process, however, is not to be construed as limited to the particular embodiments shown, as these embodiments are regarded as exemplary rather than restrictive. Moreover, variations and changes may be made by others who are skilled in the art without departing from the spirit and scope of the process of the catalytically activated dental treatment process disclosed herein. All changes that come within the meaning and range of equivalency of the claims are to be embraced within their scope.

What is claimed is:

1. A process for treating teeth comprising:
A teeth cover that abuts to a users teeth; and
placing a teeth treating agent on the inside of said cover or placing said treating agent directly on teeth; and placing said cover against said teeth; and
exposing said treatment agent to a catalytic source wherein said teeth are treated.

2. The process as set forth in claim 1 wherein said catalytic source is a form of electromagnetic radiation.

3. The process of claim 2 wherein the catalytic source is in the form of ultraviolet light.

4. The process of claim 2 wherein the catalytic source is in the form of visible light.

5. The process of claim 2 wherein the catalytic source is in the form of heat.

6. The process of claim 2 wherein the catalytic source is in the form of ultrasonic energy.

7. The process of claim 2 wherein the catalytic source is in the form of infrared light.

8. The process as set forth in claim 1 wherein said teeth cover is made of wax.

9. The process as set forth in claim 1 wherein said teeth cover is made of a thermoplastic material.

10. The process as set forth in claim 1 wherein said teeth cover is a preformed, thermoplastic stock mouth tray which approximates the shape of the human dental arch, and is substantially U-shaped, in cross-section.

11. The teeth cover as set forth in claim 10 is custom formed directly within the mouth.

12. The teeth cover as set forth in claim 11 is softened by warming it with a heat source to a temperature in excess of 98.6 degrees Fahrenheit, and then manually adapting it to ones teeth and gums.

13. The teeth cover as set forth in claim 12 is formed by occluding on said teeth cover and applying suction and pressure from the tongue and lips, wherein a balanced occlusion is achieved.

14. The process as set forth in claim 1 wherein said teeth cover is made from a synthetic material.

15. The process as set forth in claim 1 wherein said teeth cover is made from preformed stock trays that are connected together.

16. The process as set forth in claim 1 wherein said teeth cover is made from preformed stock trays that are not connected together.

17. The process as set forth in claim 1 wherein said teeth cover is made from a substantially U-shaped or L-shaped tray.

18. The process as set forth in claim 1 wherein said teeth cover is made from a plastic strip.

19. The process as set forth in claim 1 wherein said teeth cover has reservoirs.

20. The process as set forth in claim 1 wherein said teeth cover is formed by adapting said cover to said teeth indirectly by a laboratory process.

21. The process as set forth in claim 20 wherein said teeth cover is made by vacuum or pressure forming a sheet of thermoplastic material over a cast model made from an impression of a user's teeth.

22. The process as set forth in claim 1 wherein the said treatment gel is any oxidizing or reducing substance.

23. The process as set forth in claim 1 wherein at least one treatment agent is selected from a group consisting of teeth whitening agents, or desensitizing agents, or anticariogenic agents, or antimicrobial agents, or mixtures thereof for providing the desired treatment of the person's teeth, gums, or a combination of teeth and gums is used.

24. The process as set forth in claim 1 wherein said teeth cover is a thermoplastic material which is substantially in the shape of a horseshoe for receiving the teeth in a dental arch, is heated to a temperature in excess of normal human body temperature, to the point of being pliable, and a tray is formed to ones teeth.

25. The process as set forth in claim 1 wherein a teeth cover is made of a combination of synthetic polymers and copolymers.

26. The process as set forth in claim 1 wherein the cover is made of a thermoplastic material which is heated above 98.6 degrees Fahrenheit and is directly adapted to said teeth by occluding against said cover to form a cover that snugly encompasses said teeth.

27. A second teeth cover is formed to the teeth cover formed in claim 13, using the same process of claim 13, for the teeth in the opposite arch from said teeth cover wherein the second teeth cover interdigitates with said teeth cover of claim 13 and the user achieves a balanced occlusion between the two teeth covers.

28. The process as set forth in claim 13 wherein the occluding is done in a way as not to bite through said teeth cover.

29. The process as set forth in claim 1 wherein the cover is made of a thermoplastic material and heated above 98.6 degrees Fahrenheit and is directly adapted to said teeth manually and by suction.

30. The process as set forth in claim 1 wherein the cover is made of a thermoplastic material and heated above 98.6 degrees Fahrenheit and is directly adapted to said teeth and the user then occludes against said cover.

31. The process as set forth in claim 1 wherein the teeth treatment agent is a whitening agent.

32. The process of claim 31 wherein the whitening agent contains a photosensitizing agent.

33. The process as set forth in claim 9 wherein said teeth cover is made of a thermoplastic material that is from 0.03 to 1.8 millimeters thick.

34. The process as set forth in claim 9 wherein said teeth cover is made of EVA or ULDPE.

35. The process as set forth in claim 1 wherein said catalytic source is not attached to said tray.

36. The process as set forth in claim 1 wherein said catalytic source is retained by the teeth or lips of the user.

37. The process as set forth in claim 1 wherein the catalytic source has a lip hub.

38. The process as set forth in claim 1 wherein the catalytic source is a device that is attached to a control housing and has a timer, on/off switch and an audible alarm.

39. A process for treating teeth comprising:
A teeth cover that conforms to a users teeth; and
placing a teeth treating agent on the inside of said cover or placing said treating agent directly on teeth; and placing said cover against said teeth; and
retracting ones cheeks and lips with a retractor; and
exposing said teeth to a catalytic source whereby said teeth are treated.

40. A process as in claim 39 wherein a whitening agent is used in a tanning bed or enclosure.

41. A process as in claim 1 wherein said treating agent is hydrogen peroxide and or a persulfate.

42. A process as in claim 31 wherein said whitening agent contains a pigment.

43. A process of exposing a teeth treating agent within a teeth treating cover to a catalytic source; and
placing said cover over a dental arch.
